(19) United States
(12) Patent Application Publication
(10) Pub. No.: US 2009/0218393 A1
(43) Pub. Date: Sep. 3, 2009

(54) METHOD FOR DISPOSING RFID TAG AND SYSTEM THEREOF

(76) Inventors: Chi-Cheng HUANG, Taipei County (TW); Wei-Tse Cheng, Taipei County (TW)

Correspondence Address: Muncy, Geissler, Olds & Lowe, PLLC, P.O. BOX 1364, FAIRFAX, VA, 22038-1364, US

(21) Appl. No.: 12/347,636

(22) Filed: Dec. 31, 2008

(30) Foreign Application Priority Data
Feb. 29, 2008 (TW) 097107056

(51) Int. Cl. G06F 19/00

(52) U.S. Cl. 235/375

(57) ABSTRACT

A method for disposing an RFID tag and a system thereof are provided. The RFID tag is disposed on a revolving region of an object. When the object rolls on a transporting platform, the object revolves around the revolving region. Therefore, an RFID reader reads a signal data transmitted from the RFID tag on the revolving region. In addition, the method can also be applied to a model that an object wraps a revolving axis of a transporting platform, and an RFID tag is disposed on a revolving region of the revolving axis of the transporting platform. When the revolving axis of the transporting platform rotates, an RFID reader can read correctly a signal data transmitted by the RFID tag on the revolving region of the revolving axis.

### CROSS-REFERENCE TO RELATED APPLICATION

This application claims the benefit of Taiwan Patent Application No. 097107056, filed on Feb. 29, 2008, which is hereby incorporated by reference for all purposes as if fully set forth herein.

### BACKGROUND OF THE INVENTION

1. Field of the Invention

The present invention relates to a method for disposing an RFID (Radio-frequency identification) tag and a system thereof, and more particularly to a method for disposing an RFID tag on a revolving region of a product or a transporting platform and a system thereof.

2. Related Art

In recent years, there is an increasingly high demand for tracking products in the electronics manufacturing industry, in order to reduce a manufacturing cost and improve product quality and competitiveness as well. Therefore, if it lacks a balance for checking the product, and the acquired information of the products is complete and correct, thus the tracking of the products is meaningless.

Referring to FIG. 1, a current product tracking manner is shown. An RFID tag 101 is disposed on an edge of a product 10, and then the product information transmitted by the RFID tag 101 is read by using an RFID reader. Unfortunately, when the RFID tag 101 of the product 10 rolls or rotates together with the product 10, reading errors or misreading of the RFID reader often occur, thereby resulting in inconveniences in use.

### SUMMARY OF THE INVENTION

In view of the above, the present invention is directed to a method for disposing an RFID tag and a system thereof, which are adapted to dispose the RFID tag on a revolving region of a product or a transporting platform, thereby improving the reading accuracy of the RFID tag.

In order to solve the above problems, one of the solutions proposed by the present invention is to provide a method for disposing an RFID tag, which mainly includes the following steps. A revolving region of a product is calculated, and an RFID tag is disposed on the revolving region of the product. The product is loaded to a transporting platform, and once the transporting platform is turned by an electric motor to drive the product to roll on the transporting platform, the product rotates around the revolving region, which enables an RFID reader to read a signal data sent by the RFID tag built on the revolving region. Thus, the information of the product is acquired without producing a multi-directional signal due to the rolling of the product on the transporting platform.

The method for disposing an RFID tag of the present invention can also be applied to a configuration that a product wraps a revolving axis of a transporting platform. The method mainly includes the following steps. The product wraps the revolving axis of the transporting platform, then a revolving region of the revolving axis of the transporting platform is calculated, and the RFID tag is disposed on the revolving region of the revolving axis. When the transporting platform is turned by an electric motor to rotate the revolving axis of the transporting platform rotates around the revolving region, which enables an RFID reader to read a signal data sent by the RFID tag disposed on the revolving region. Thus, the information of the product is acquired without producing a multi-direction signal due to the rotation of the revolving axis.

In addition, in an RFID tag system of the present invention, an RFID tag is disposed on a revolving region of a product or a revolving axis of a transporting platform. The product or the revolving axis of the transporting platform rotates around the revolving region, and an RFID reader merely reads a signal data sent by the RFID tag disposed on the revolving region. Thus, the information of the product is acquired without producing a multi-direction signal due to the rotation. The product or the revolving axis of the transporting platform is cylindrical-shaped.

In the method for disposing an RFID tag and the system thereof of the present invention, an RFID tag is disposed on a revolving region of a product or a revolving axis of a transporting platform, which enables energy of a signal transmitted by the RFID tag to become more centralized and the signal has a relatively narrow antenna beam width feature. Therefore, when an RFID reader reads the signal transmitted by the RFID tag, fewer reading errors or reading failures occur due to the rolling of the product or the rotation of the revolving axis of the transporting platform.

### BRIEF DESCRIPTION OF THE DRAWINGS

The present invention will become more fully understood from the detailed description given herein below for illustration only, which thus is not limitative of the present invention, and wherein:

FIG. 1 is a method for disposing an RFID tag and a system thereof in the prior art;

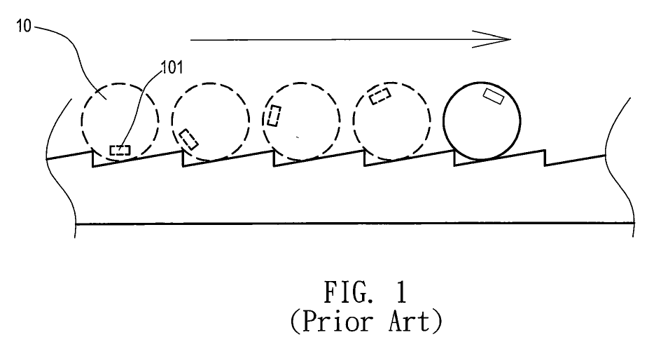

FIG. 2 is a flow chart of a method for disposing an RFID tag according to a first embodiment of the present invention;

FIG. 3 is a schematic structural view of an RFID system according to the first embodiment of the present invention;

FIG. 4 is a flow chart of a method for disposing an RFID tag according to a second embodiment of the present invention;

FIG. 5 is a schematic structural view of an RFID system according to the second embodiment of the present invention;

FIG. 6A is an axial ratio diagram of a tag in a method for disposing an RFID tag and a system thereof according to an embodiment of the present invention; and

FIG. 6B is a beam width diagram of an RFID tag in a method for disposing an RFID tag and a system thereof according to an embodiment of the present invention.

### DETAILED DESCRIPTION OF THE INVENTION

In order to further understand the disclosure of the present invention, a detailed illustration is made below with reference to related embodiments and the drawings.

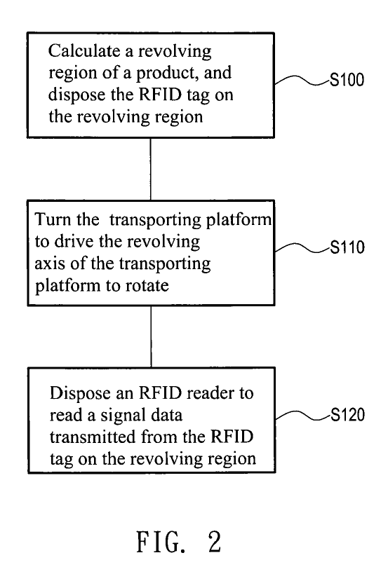

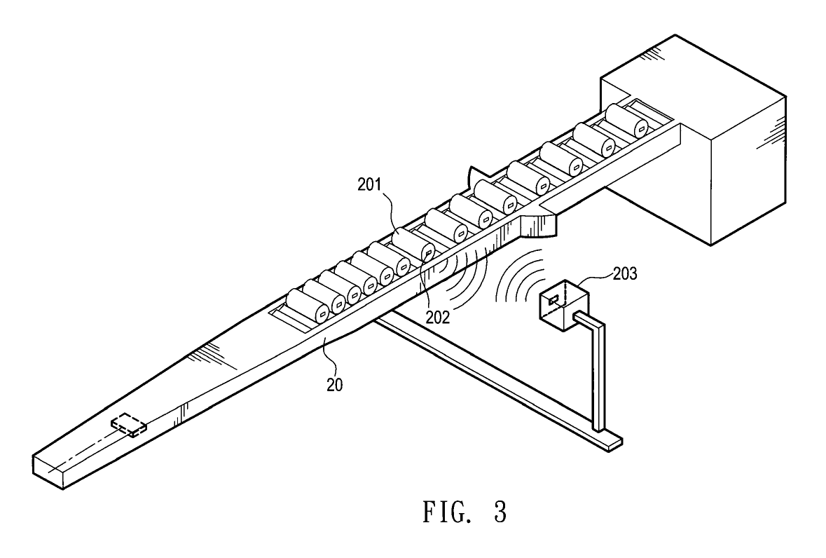

FIG. 2 is a flow chart of a method for disposing an RFID tag according to a first embodiment of the present invention, and FIG. 3 is a schematic structural view of an RFID tag system according to the first embodiment of the present invention. Referring to FIGS. 2 and 3, the method mainly includes the following steps.

A revolving region of a product is calculated, and an RFID tag is disposed on the revolving region of the product (Step S100). A signal transmitted by the RFID tag 202 on the product 201 is often interfered and cannot be delivered correctly due to different disposing positions of the RFID tag 202 on the product 201. The reason mainly lies in that a multi-direction signal is produced due to the rolling of the product 201 on a transporting platform 20. Therefore, the present invention first calculates the revolving region of the rolling surface of the product 201, and disposes the RFID tag 202 on the revolving region, so that the RFID tag 202 can improve the reading accuracy of an RFID reader 203 through the antenna radiation field property. Then, the product is placed on the transporting platform, and the transporting platform is turned by an electric motor to drive the product to roll on the transporting platform (Step S110).

An RFID reader is disposed to read a signal data transmitted by the RFID tag on the revolving region (Step S120). When the product 201 rolls on the transporting platform 20, the product rotates around the revolving region, so that the RFID reader 203 reads sequentially the signal data sent by the RFID tag 202 on the revolving region of the product 201, thereby acquiring the information of the product 201.

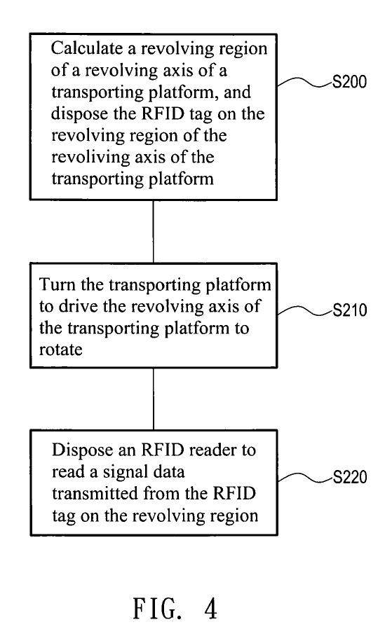

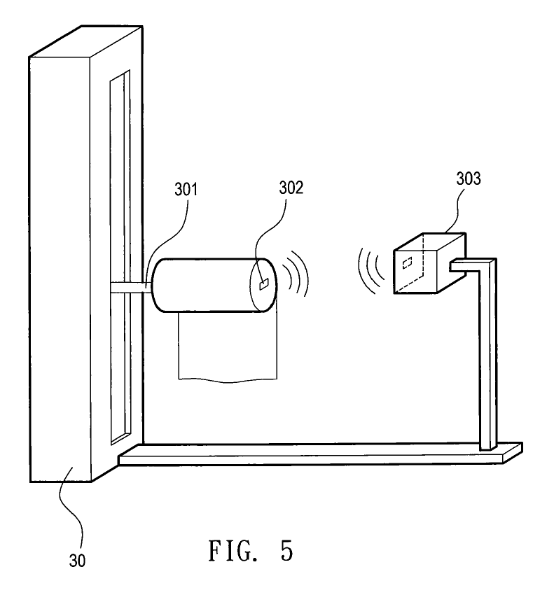

FIG. 4 is a flow chart of a method for disposing an RFID tag according to a second embodiment of the present invention, and FIG. 5 is a schematic structural view of an RFID tag system according to the second embodiment of the present invention. Referring to FIGS. 4 and 5, the method mainly includes the following steps.

A revolving region of a revolving axis of a transporting platform is calculated, and an RFID tag is disposed on the revolving region of the revolving axis of the transporting platform (Step S200). A signal transmitted by the RFID tag 302 disposed on the revolving axis 301 of the transporting platform 30 is often interfered and cannot be delivered correctly due to different disposing positions of the RFID tag 302 on the revolving axis 301 of the transporting platform 30. The reason mainly lies in that the product 201 produces a multi-direction signal on the revolving axis 301 of the transporting platform 30. Therefore, the present invention first calculates the revolving region of the rotating surface of the revolving axis 301 of the transporting platform 30, and disposes the RFID tag 302 on the revolving region of the rotating surface of the revolving axis 301 of the transporting platform 30, so that the RFID tag 302 can improve the reading accuracy of an RFID reader 303 through the antenna radiation field property. Then, the transporting platform is further turned by an electric motor to drive the revolving axis of the transporting platform to rotate (Step S210).

An RFID reader is disposed to read a signal data transmitted by the RFID tag on the revolving region (Step S220). When the revolving axis 301 of the transporting platform 30 rotates around the revolving region, the RFID reader 303 reads the signal data sent by the RFID tag 302 disposed on the revolving region of the revolving axis 301 of the transporting platform 30, thereby acquiring the information of the product placed on the revolving axis 301 of the transporting platform 30.

In the above embodiments, the product or the revolving axis of the transporting platform is cylindrical-shaped. As for an RFID tag system of the present invention, an RFID tag is disposed on a revolving region of a product or a revolving axis of a transporting platform. The product rolls around the revolving region or the revolving axis of the transporting platform rotates around the revolving region, which enables an RFID reader to read a signal data sent by the RFID tag disposed on the revolving region. Thus, the information of the product is acquired without producing a multi-direction signal due to the rolling of the product or the rotation of the revolving axis of the transporting platform.

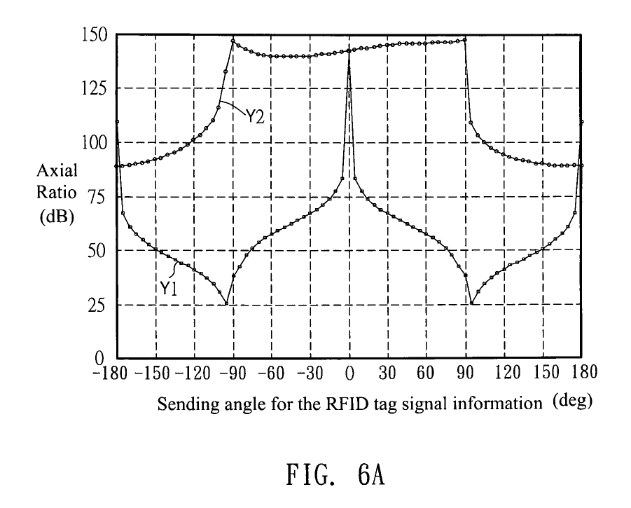

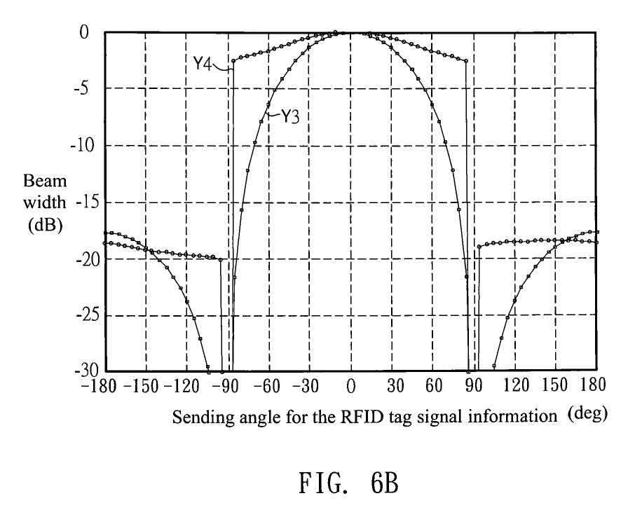

Referring to FIGS. 6A and 6B, FIG. 6A is an axial ratio diagram of a tag in a method for disposing an RFID tag and a system thereof according to an embodiment of the present invention, and FIG. 6B is a beam width diagram of an RFID tag in a method for disposing an RFID tag and a system thereof according to an embodiment of the present invention.

Antenna patterns exhibited by the antennas of the RFID tag are shown in FIGS. 6A and 6B. Curves Y1 and Y2 in FIG. 6A represent antenna patterns of an RFID tag, which the antenna member is arranged orthogonal, and as known from the curves, the antenna energy of the RFID tag is centralized in a direction perpendicular to an antenna surface and is most centralized close to a central position. Curves Y3 and Y4 in FIG. 6B represent of an RFID tag, which the antenna member is arranged orthogonal, and as known from the curves, the antenna patterns of antennas of the RFID tag is approximately ellipse-shaped, and the energy is most strong in the central position. Therefore, according to the results shown in FIGS. 6A and 6B, when the RFID tag, disposed on the revolving region of the product or the revolving axis of the transporting platform, rotates together with the product or the revolving axis of the transporting platform, the antenna energy of the RFID tag may be centralized on a center position and a front surface, thereby improving the reading accuracy and reliability of the RFID reader.

To sum up, in the method for disposing an RFID tag and the system thereof of the present invention, an RFID tag is disposed on a revolving region of a product or a revolving axis of a transporting platform, so as to avoid the defects of failing to read accurately or misreading caused by the rolling of the product or the rotation of the revolving axis of the transporting platform when an RFID reader reads a signal transmitted by the RFID tag.

The present invention has been particularly described with reference to the exemplary embodiments, so that it will be apparent to those skilled in the art that various modifications and variations can be made to the system of the present invention without departing from the scope or spirit of the invention. In view of the foregoing, it is intended that the present invention cover modifications and variations of this invention provided they fall within the scope of the following claims and their equivalents.

What is claimed is:

1. A method for disposing a radio-frequency identification (RFID) tag, comprising:
calculating a revolving region of a product, and disposing the RFID tag on the revolving region;
placing the product on a transporting platform, and turning the transporting platform to drive the product to roll on the transporting platform; and
disposing an RFID reader to read a signal data transmitted from the RFID tag on the revolving region.

2. The method for disposing an RFID tag according to claim 1, wherein the product is cylindrical-shaped.

3. The method for disposing an RFID tag according to claim 1, wherein the transporting platform is turned by at least one electric motor.

4. A method for disposing a radio-frequency identification (RFID) tag, comprising:
calculating a revolving region of a revolving axis of a transporting platform, and disposing the RFID tag on the revolving region of the revolving axis of the transporting platform;
turning the transporting platform to drive the revolving axis of the transporting platform to rotate; and
disposing an RFID reader to read a signal data transmitted from the RFID tag on the revolving region.

5. The method for disposing an RFID tag according to claim 4, wherein the revolving axis of the transporting platform is cylindrical-shaped.

6. The method for disposing an RFID tag according to claim 4, wherein the transporting platform is turned by using at least one electric motor.

7. A radio-frequency identification (RFID) tag system, comprising:
a product, comprising an RFID tag on a revolving region thereof, wherein the product rotates around the revolving region; and
an RFID reader, for reading a signal data transmitted from the RFID tag on the revolving region.

8. The RFID tag system according to claim 7, wherein the product is cylindrical-shaped.

9. The RFID tag system according to claim 7, further comprising a transporting platform for rotating the product through turning the transporting platform.

10. The RFID tag system according to claim 9, wherein the transporting platform is turned by at least one electric motor.

11. A radio-frequency identification (RFID) tag system, comprising:
a revolving axis of a transporting platform, comprising an RFID tag on a revolving region thereof, wherein the revolving axis rotates around the revolving region; and
an RFID reader, for reading a signal data transmitted from the RFID tag on the revolving region.

12. The RFID tag system according to claim 11, wherein the revolving axis of the transporting platform is cylindrical-shaped.

13. The RFID tag system according to claim 11, wherein the transporting platform is turned by at least one electric motor.
